(19) United States
(12) Patent Application Publication
(10) Pub. No.: US 2021/0374630 A1
(43) Pub. Date: Dec. 2, 2021

(54) METHOD AND SYSTEM FOR MULTISITE LEGAL PROFILING FOR BACKUP DATA

(71) Applicant: EMC IP Holding Company LLC, Hopkinton, MA (US)

(72) Inventors: Chetan Battal, Bangalore (IN); Mahesh Reddy Appireddygari Venkataramana, Bangalore (IN); Swaroop Shankar D H, Bangalore (IN); Shelesh Chopra, Bangalore (IN)

(21) Appl. No.: 16/925,938

(22) Filed: Jul. 10, 2020

(30) Foreign Application Priority Data
May 27, 2020 (IN) 202041022233

(51) Int. Cl. G06Q 10/06; G06F 21/62; G06F 21/64; G06F 11/14

(52) U.S. Cl. CPC G06Q 10/0635; G06F 11/1448; G06F 21/64; G06F 21/6227

(57) ABSTRACT

A method and system for verifying compliance of data objects in backup systems that includes a local compliance engine obtaining a data profile of a data object, the data object being stored on a production host in a region. The local compliance engine identifies an ideal profile corresponding to the data profile, and the data profile is compared to the ideal profile. Mismatches are identified between the data profile and the ideal profile based on the comparison, and an alert is generated based on the identified mismatches. The alert is transmitted to a user system and a centralized compliance system.

### BACKGROUND

In data protection scenarios, there may be certain legal regulations that have to be followed and audit compliance that need to be ensured. Such regulations and compliance may be region specific because different regions likely have different International Standard Organization (ISO) standards, legal requirements on the data being used, or government profiling that must take place. Traditionally, for backup applications that are managing backups across multiple regions, it is challenging to automatically manage all of the per-region legal regulations and audit compliance requirements. As a result, many traditional approaches rely on some form of manual compliance system; however, this approach is error prone and requires a significant amount of administrative overhead.

### SUMMARY

In general, in one aspect, the invention relates to a method for verifying compliance of data objects in backup systems that includes a local compliance engine obtaining a data profile of a data object, the data object being stored on a production host in a region. The local compliance engine identifies an ideal profile corresponding to the data profile, and the data profile is compared to the ideal profile. Mismatches are identified between the data profile and the ideal profile based on the comparison, and an alert is generated based on the identified mismatches. The alert is transmitted to a user system and a centralized compliance system.

In general, in one aspect, the invention relates to a non-transitory computer readable medium that includes computer readable program code, which when executed by a computer processor enables the computer processor to perform a method for verifying compliance of data objects in backup systems that includes a local compliance engine obtaining a data profile of a data object, the data object being stored on a production host in a region. The local compliance engine identifies an ideal profile corresponding to the data profile, and the data profile is compared to the ideal profile. Mismatches are identified between the data profile and the ideal profile based on the comparison, and an alert is generated based on the identified mismatches. The alert is transmitted to a user system and a centralized compliance system.

In general, in one aspect, the invention relates to a system that includes a processor and memory that includes instructions, which when executed by the processor perform a method for verifying compliance of data objects in backup systems that includes a local compliance engine obtaining a data profile of a data object, the data object being stored on a production host in a region. The local compliance engine identifies an ideal profile corresponding to the data profile, and the data profile is compared to the ideal profile. Mismatches are identified between the data profile and the ideal profile based on the comparison, and an alert is generated based on the identified mismatches. The alert is transmitted to a user system and a centralized compliance system.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2 shows a diagram of a local compliance engine in accordance with one or more embodiments of the invention.

FIG. 3 shows a flowchart for preserving rules in accordance with one or more embodiments of the invention.

FIG. 4 shows a flowchart for distributing rules a in accordance with one or more embodiments of the invention.

FIG. 5 shows a flowchart for verifying compliance in accordance with one or more embodiments of the invention.

FIG. 6 shows a flowchart for verifying compliance in accordance with one or more embodiments of the invention.

FIG. 7 shows a flowchart for verifying compliance in accordance with one or more embodiments of the invention.

FIG. 8 shows a flowchart for reporting compliance verifications in accordance with one or more embodiments of the invention.

FIG. 9 shows a flowchart for modifying profiles in accordance with one or more embodiments of the invention.

FIG. 10 shows a flowchart for reporting compliance verifications in accordance with one or more embodiments of the invention.

FIG. 11 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N, or A to M. As used herein, the aforementioned labeling means that the element may include any number of items and does not require that the element include the same number of elements as any other item labeled as A to N or A to M. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

In general, embodiments of the invention may relate to a method and system for ensuring region-specific legal and audit compliance for data protection across multiple regions. Embodiments include a profiling engine for monitoring data objects and ensuring profiling is matched per an ideal profile stored in the engine. In some embodiments disclosed herein, if a mismatch in the profiles is identified, a recommendation to ensure a profiling match is presented to a user. In one or more embodiments, the user may ensure the profiling match and further instruct the server to repeat the action for similar profiles.

In embodiments disclosed herein, data (in the form of data objects) may be protected from multiple sites utilizing a local profiling engine to ensure that each data object in a location complies with standards as per the local government and/or the user. In one embodiment of the invention, a data object may be any file in any format with any type of content (e.g., audio, visual, images, text, audiovisual, etc.).

In embodiments disclosed herein, a profile refers to a collection of the rules and/or standards that has to be compulsorily applied on a type of data object. For example, the profile may specify that a signature is required on a data object that is classified as a legal document. In another example, the profile may require that data object comply with one or more International Organization of Standardization (ISO) standards. In another example, the profile may specify a size limit if the data object is a classified as a government log file. The invention is not limited to the aforementioned examples.

In one or more embodiments, a profiling engine ensures that a profile is matched or the profiling engine triggers a recommendation/alerting engine to indicate to backup administrators that there is a mismatch on particular file as per the data object's legal profile. At the same time, a user may also be alerted to which rules and/or standards apply to the particular data object. The user may also have the option of providing feedback in response to an alert or notification.

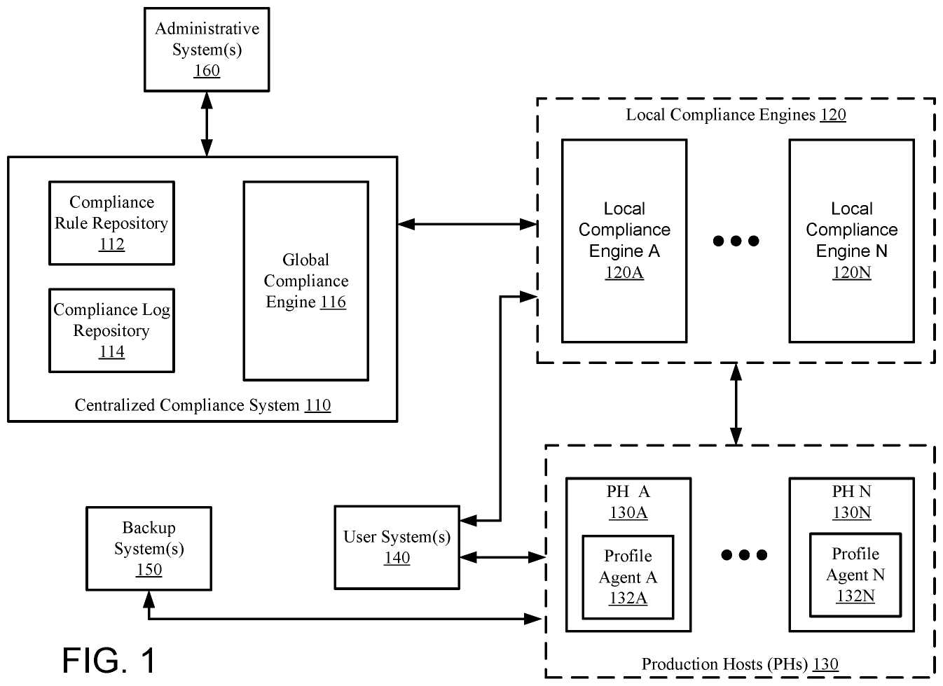

FIG. 1 shows an example of a system in accordance with one or more embodiments disclosed herein. The system includes a centralized compliance system (110), one or more local compliance engines (120), and one or more production hosts (130). The system may also include one or more user systems (140), one or more backup systems (150), and one or more administrative systems (160). The system may include additional, fewer, and/or different components without departing from the invention. Each component may be operably connected to any of the other components via any combination of wired and/or wireless connections. Each of the aforementioned components is discussed below.

In one embodiment of the invention, the centralized compliance system (110) includes a compliance rule repository (112), a compliance log repository (114), and a global compliance engine (116). Each of the components is described below.

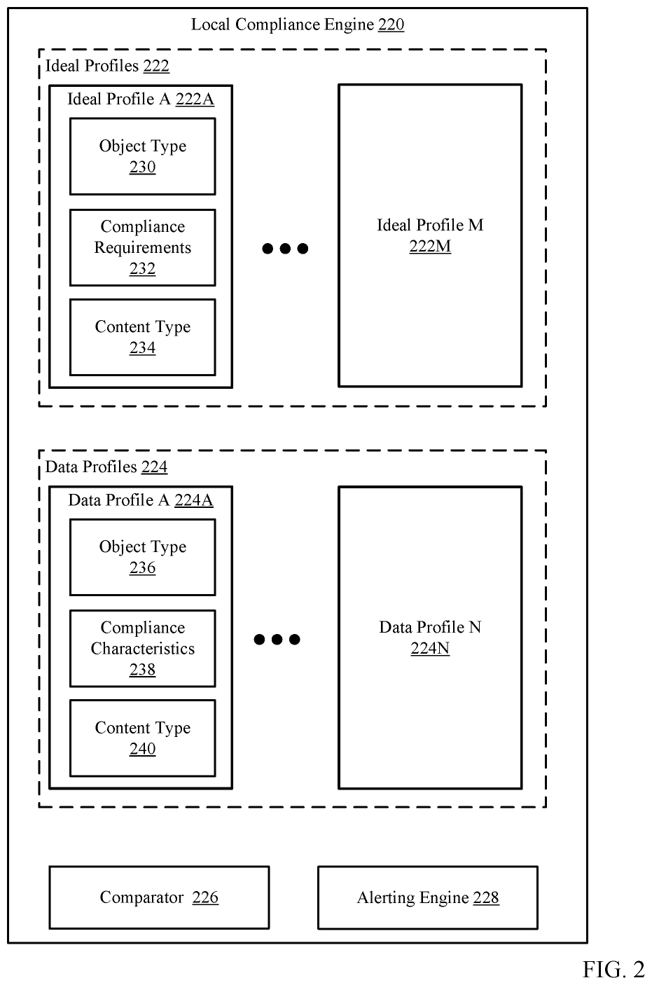

In one embodiment of the invention, the compliance rule repository (112) stores one or more compliance rules. The compliance rules (not shown) include sufficient information to generate the ideal profiles (see e.g., FIG. 2). More specifically, each compliance rule corresponds to a legal requirement (which may be specified by a governmental entity) (e.g., the General Data Protection Regulation (GDPR), the California Consumer Privacy Act (CCPA), etc.) and/or a requirement that is specified by the entity that owns or controls that a data object (e.g., all data objects of a particular type need to be encrypted). The rules also specify the type of content to which the rule applies, e.g., images, audio, text as well as data object type (also referred to as object type) to which the rule applies. The object type may correspond to the specific format of the data e.g., portable document format (PDF) files, .docx files, .jpeg files, etc. Additionally, or alternatively, the object type may also specify additional characteristics of the document such as whether it is legal document, an engineering design document, etc.

In one embodiment of the invention, the compliance log repository (114) stores records (or logs) of any interactions with the compliance rule repository (112). The logs of interactions may include any changes to the compliance rule repository (112), as well as the relevant parties and information associated with such changes. The changes may be result of changes made by administrators via the administrative systems and/or changes resulting from feedback provided by the user (via user systems (as described below)). In addition, the compliance log repository may also log when data objects do not match the corresponding ideal profile (as described below). In this manner, the compliance logs repository may be used to audit user and/or entity (e.g., company compliance) with the compliance rules.

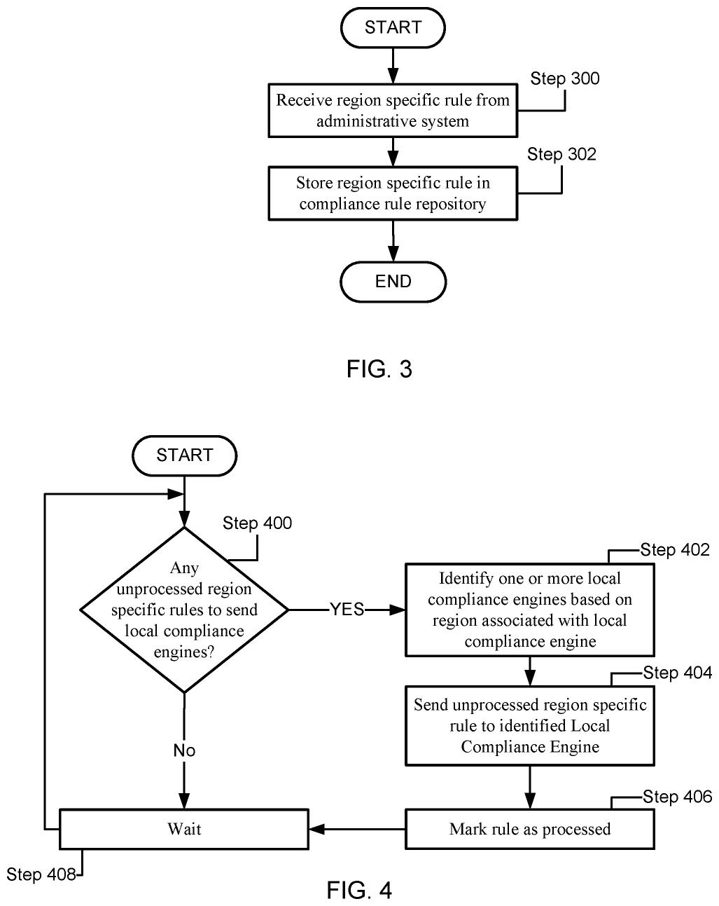

In one embodiment of the invention, the global compliance engine includes functionality to generate and distribute local compliance rules to the local compliance engines (120A, 120N). The global compliance engine (116) may also be capable of performing comparisons and functions as described herein similar to the local compliance engines (120A, 120N) described in FIG. 2. The global compliance engine (116) includes functionality to implement the aforementioned functionality described throughout this application and/or all, or a portion thereof, of the methods illustrated in FIGS. 3, 4, 8 and 10.

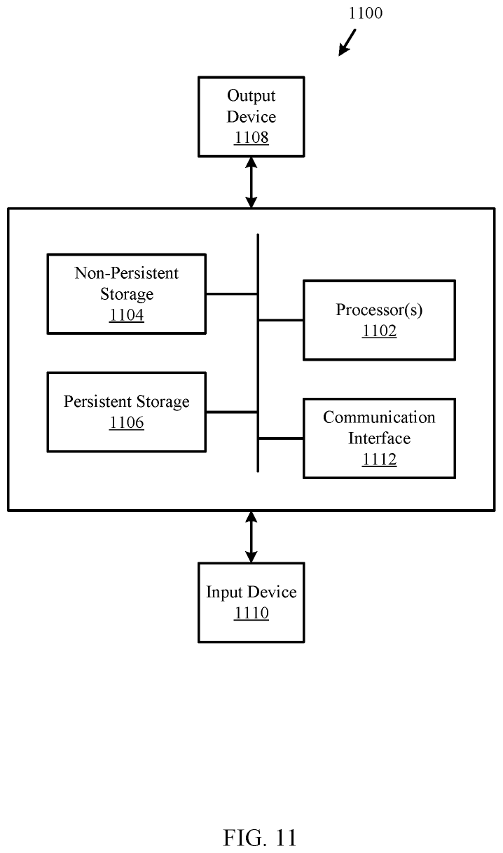

In one or more embodiments of the invention, the centralized compliance system (110) is implemented as a computing device (see e.g., FIG. 11). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform functionality of the centralized compliance system (110) described throughout this application and/or all, or a portion thereof, of the methods illustrated in FIGS. 3, 4, 8 and 10.

In one or more embodiments of the invention, the centralized compliance system (110) is implemented as a logical device. The logical device may utilize the computing resources of any number of computing devices and thereby provide the functionality of the centralized compliance system (110) described throughout this application and/or all, or a portion thereof, of the methods illustrated in FIGS. 3, 4, 8 and 10.

Embodiments of the system also include administrative systems (160). The administrative systems (160) are operable connected to the centralized compliance system (110) to monitor and/or implement the centralized region specific compliance controls and systems described herein.

The administrative systems (160) may also be used for administrative purposes such as comparing compliance requirements for different regions, comparing previous versions of compliance requirements to current versions, analyzing changes to compliance requirements of specific regions, etc.

In the embodiments described above, the administrative systems (160) are demonstrated as a separate entity from the centralized compliance system (110); however, embodiments herein are not limited as such. The administrative systems (160) and central compliance system (110) may be a part of the same entity.

In one or more embodiments of the invention, the administrative systems (160) are implemented as a computing device (see e.g., FIG. 11). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform functionality of the administrative systems (160) described throughout this application.

In one or more embodiments of the invention, the centralized compliance system (110) is implemented as a logical device. The logical device may utilize the computing resources of any number of computing devices and thereby provide the functionality of the centralized compliance system (110) described throughout this application.

The system also includes a collection of local compliance engines (120A, 120N) and production hosts (130). The local compliance engines (120A, 120N) are each located in or near the regions for which compliance is desired. The local compliance engines (120A, 120N) are described in further detail with respect to FIG. 2. The local compliance engines (120) are operably connected to the production hosts (130). Every local compliance engine may be associated with at least one production host. However, one of ordinary skill in the art will appreciate that a one to one correspondence between the production host (130A, 130N) and the local compliance engines (120A, 120N) may not be necessary. Each production host (130A) includes a profile agent (132A, 132N). The profile agent (132A, 132N) is responsible for determining the profile of a data object in accordance with one or more embodiments disclosed herein.

As shown in FIG. 1, a local compliance engine (120A) may be a separate entity from the production host (130A, 130N); however, embodiments disclosed herein are not limited as such. The local compliance engine (120A) and production host (132A) may be combined into a single entity.

The system also includes user systems (140) and backup systems (150). In one or more embodiments, the backup systems (150) include functionality to store backups of one or more production hosts (or portions thereof).

In one or more embodiments of the invention, the production hosts (130A, 130N) are implemented as a computing device (see e.g., FIG. 11). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the production host (130A, 130N) described throughout this application.

In one or more embodiments of the invention, the production hosts (130A, 130N) are implemented as a logical device. The logical device may utilize the computing resources of any number of computing devices and thereby provide the functionality of the production host (130A, 130N) described throughout this application.

In one or more embodiments of the invention, the user systems (140) are implemented as a computing device (see e.g., FIG. 11). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the user systems (140) described throughout this application.

In one or more embodiments of the invention, the user systems (140) are implemented as a logical device. The logical device may utilize the computing resources of any number of computing devices and thereby provide the functionality of the user systems (140) described throughout this application.

In one or more embodiments of the invention, the backup systems (150) is implemented as a computing device (see e.g., FIG. 11). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the backup storage device described throughout this application.

Embodiments disclosed herein are not limited to the specific configuration of the system demonstrated in FIG. 1. One of ordinary skill in the art will appreciate that the specific configuration and connections shown in FIG. 1 may be modified and still achieve the purpose of verifying region specific compliance when storing data objects.

FIG. 2 shows a diagram of a local compliance engine in accordance with one or more embodiments of the invention. The local compliance engine (220A) includes ideal profiles (222A, 222M) associated with the one or more regions to which the local compliance engine is assigned. The local compliance engine (220A) also includes the data object profiles (224) to be compared to the ideal profiles (222). The local compliance engine (220A) may also include data profiles that have been previously compared to an ideal profile (222). The local compliance engine (220A) also includes a comparator (226) that is used to compare characteristics of an ideal profile (222) to a data profile (224). The alert engine (228) is used to transmit the results of comparisons made by the comparator (226) of the local compliance engine (220).

The ideal profiles (222) include the region specific compliance requirements (232) to be compared to the compliance characteristics (238) of the data profiles (224). As shown in FIG. 2, the ideal profiles (222) and data profiles (224) also include information such as the object type (230, 236) (defined above) and content type (234, 240) (defined above) that may be used in the comparison. The compliance requirements are derived from the compliance rules stored in the compliance repository. The compliance characteristics correspond to information about the data object that may be used to determine whether the data object satisfies a compliance rule.

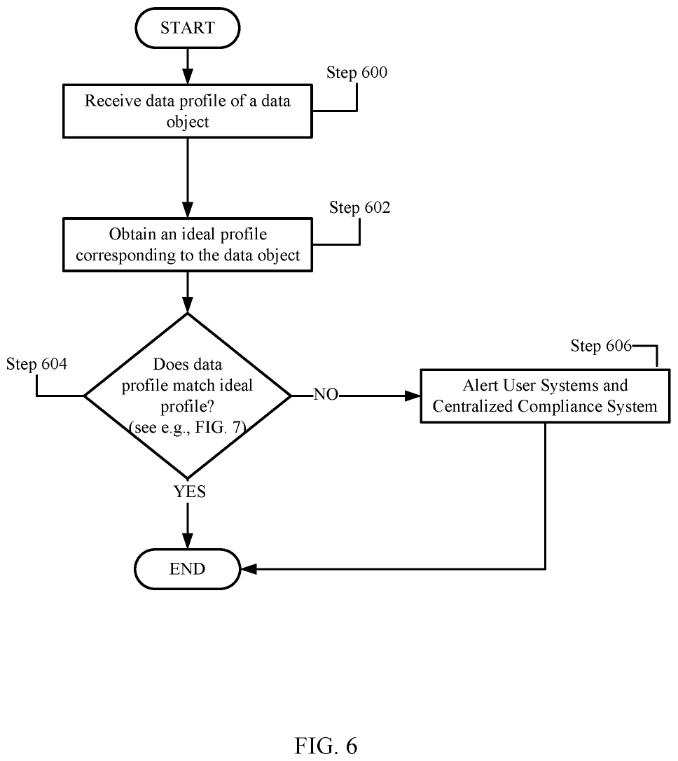

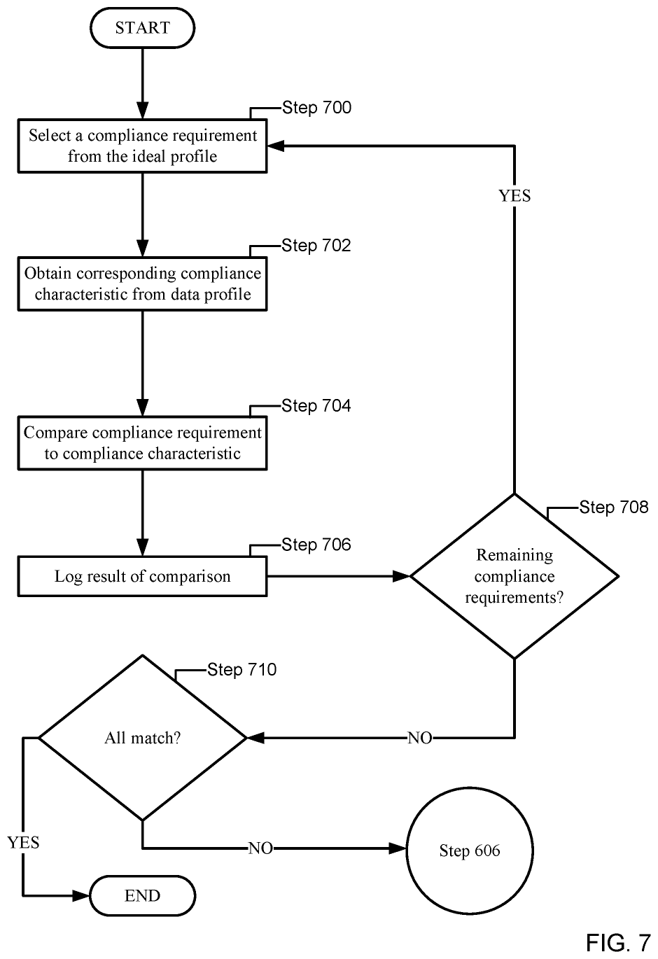

The local compliance engine (220) includes functionality to implement the aforementioned functionality described throughout this application and/or all, or a portion thereof, of the methods illustrated in FIGS. 6 and 7.

In one or more embodiments of the invention, the local compliance engine (220) is implemented as a computing device (see e.g., FIG. 11). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform functionality of the local compliance engine (220) described throughout this application and/or all, or a portion thereof, of the methods illustrated in FIGS. 6 and 7.

In one or more embodiments of the invention, the local compliance engine (220) is implemented as a logical device. The logical device may utilize the computing resources of any number of computing devices and thereby provide the functionality of the local compliance engine (220) described throughout this application and/or all, or a portion thereof, of the methods illustrated in FIGS. 6 and 7.

FIGS. 3-10 show flowcharts in accordance with one or more embodiments of the invention. While the various steps in the flowcharts are presented and described sequentially, one of ordinary skill in the relevant art will appreciate that some or all of the steps may be executed in different orders, may be combined or omitted, and some or all steps may be executed in parallel. In one embodiment of the invention, the steps shown in FIGS. 3-10 may be performed in parallel with any other steps shown in FIGS. 3-10 without departing from the scope of the invention.

FIG. 3 is a flowchart for preserving rules in accordance with one or more embodiments of the invention. The method shown in FIG. 3 may be performed by, for example, the central compliance system. Other components of the system illustrated in FIG. 1 may perform the method of FIG. 3 without departing from the invention.

In step 300, a region specific rule is received from the administrative system. The region specific rule is a compliance rule that is applicable to one or more regions (which may be countries, groups of countries, or a portion of a country). In step 302, the region specific rule is stored in the compliance rule repository. This may be performed at the initialization of the system, or at any time a region specific rule is added or modified.

FIG. 4 demonstrates a flowchart for distributing rules in accordance with one or more embodiments disclosed herein. FIG. 4 demonstrates the distribution of region specific rules to the local compliance engines. The method shown in FIG. 4 may be performed by, for example, the central compliance system. Other components of the system illustrated in FIG. 1 may perform the method of FIG. 4 without departing from the invention.

In step 400, a determination is made about whether there are any unprocessed region specific rules to send to the local compliance engines. If there an unprocessed region specific rule to be distributed, the process proceeds to step 402. In step 402, one or more local compliance engines to receive the rule are identified based on the region associated with the local compliance engine in step 402. In step 404, the unprocessed region specific rule is sent to the identified local compliance engine, and the rule is marked as processed in step 406. At this time, the system may wait (step 408), and then repeat the processes. If it is determined in step 400 that there are no unprocessed rules (NO), the system proceeds to step 408 and waits a period of time before repeating the process. Embodiments of FIG. 4 ensure that all the compliance rules are appropriately distributed to the local compliance engines.

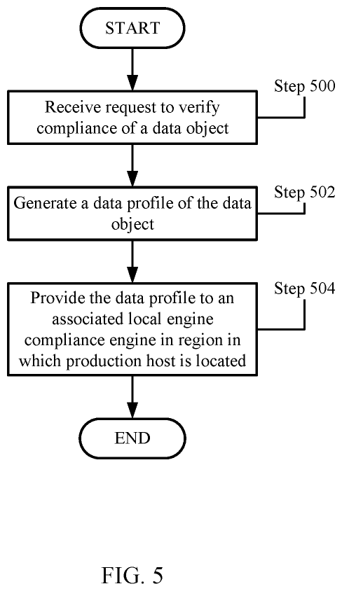

FIG. 5 shows a flowchart for verifying compliance in accordance with one or more embodiments of the invention. The method shown in FIG. 5 may be performed by, for example, a profile agent on the production host. Other components of the system illustrated in FIG. 1 may perform the method of FIG. 5 without departing from the invention. In step 500, a request to verify compliance of a data object is received. In some embodiments, the request may be received from the back systems (150) as part of a backup process for the data object. In other embodiments, the request may be received from the user systems (140) for the data object. In step 502, a data profile is generated of the data object. In some embodiments, the data profile may be determined solely from the data object. In other embodiments, the data profile of the data object may be determined from the data object and other information associated with the data object, such as region location and information related to the object type such as the document is a legal document, an engineering document, etc. In step 504, the data profile of the data object is provided to the associated local compliance engine.

FIG. 6 shows a flowchart for verifying compliance in accordance with one or more embodiments of the invention. The method shown in FIG. 6 may be performed by, for example, the local compliance engine. Other components of the system illustrated in FIG. 1 may perform the method of FIG. 6 without departing from the invention. In step 600, the data profile of a data object is received by a local compliance engine from the production host. The local compliance engine obtains an ideal profile corresponding to the data object in step 602. The local compliance engine may have a set of ideal profiles. The selected ideal profile in step 602 includes the same object type and content type as the data profile (i.e., the data profile obtained in step 600). In one or more embodiments disclosed herein, the ideal profile was received from the central compliance system in accordance FIGS. 3-4. In step 604, it is determined if the data profile matches ideal profile. This is discussed in further detail below with respect to FIG. 7. Step 604 may be performed by the comparator. If the data profile matches the ideal profile, the data object is determined to be compliant and the process ends. In some embodiments, the backup system or user system that requested the verification of the data object may be notified of the compliance of the data object at this stage. If the data profile does not match the ideal profile, the user system and centralized compliance system is alerted in step 606 using the alerting engine. The alert may include the data profile, the ideal profile, and indicate which portions of the compliance requirements that data profile fails to satisfy (i.e., the portions of the compliance requirements that do not match the compliance characteristics). The alert may include additional or different information without departing from the invention. The alert may be sent via email, via an application programming interface (API) call, or via any other communication mechanism.

FIG. 7 shows a flowchart for verifying compliance in accordance with one or more embodiments of the invention. The method shown in FIG. 7 may be performed by, for example, the local compliance engine. Other components of the system illustrated in FIG. 1 may perform the method of FIG. 7 without departing from the invention. FIG. 7 provides further details of comparing the ideal profile to the data profile and may be considered an expansion of step 604 of FIG. 6. In step 700, a compliance requirement is selected from the ideal profile. In step 702, a corresponding compliance characteristic is obtained from the data profile. The compliance requirement of the ideal profile is compared to the compliance characteristic of the data profile in step 704. The result of the comparison is logged in step 706. In step 708, it is determined if there are any other compliance requirements to be met from the ideal profile If there are any more compliance requirements (YES), the process returns to step 700 and repeats steps 700 to 706 for all the compliance requirements in the ideal profile. If there are no more remaining compliance requirements, in step 710, it is determined from the log if all the compliance characteristics match the compliance requirements, and any mismatches are identified. If there are no mismatches, the process ends. If any mismatches are identified, the user system and centralized compliance system are alerted as demonstrated in step 606 of FIG. 6.

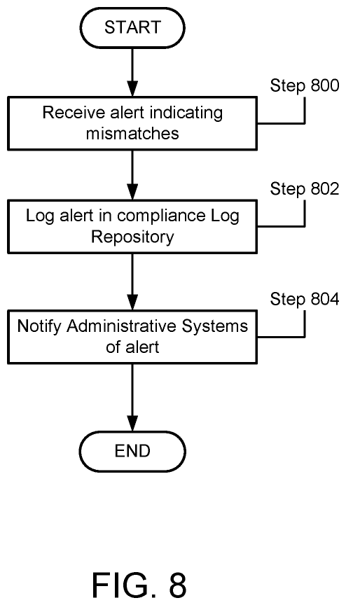

FIG. 8 shows a flowchart for reporting compliance verifications in accordance with one or more embodiments of the invention. The method shown in FIG. 8 may be performed by, for example, the central compliance system. Other components of the system illustrated in FIG. 1 may perform the method of FIG. 8 without departing from the invention. FIG. 8 provides an example process for receiving an alert in accordance with one or more embodiments disclosed herein. In step 800, an alert indicating mismatches is received. The alert may include the specific mismatches and regional information, as well as any other information relevant to the verification process. The alert is logged in the compliance log repository in step 802. In step 804, the administrative system may be notified of the alert.

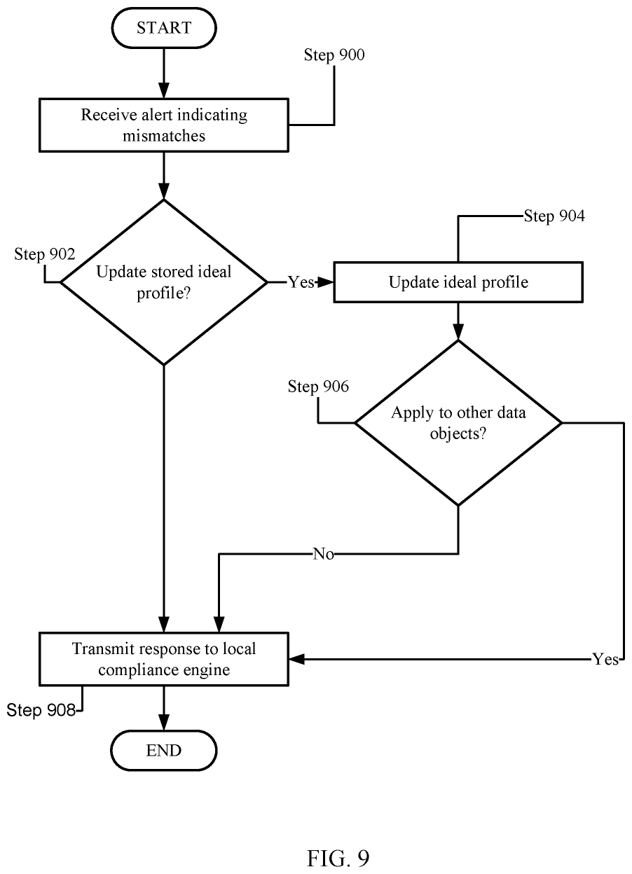

FIG. 9 shows a flowchart for modifying profiles in accordance with one or more embodiments of the invention. The method shown in FIG. 4 may be performed by, for example, the user system. Other components of the system illustrated in FIG. 1 may perform the method of FIG. 4 without departing from the invention. In step 900, the alert indicating the mismatches is received. In step 902, an option to update the ideal profile in the local compliance engine based on the mismatches is provided, e.g., via a graphical user interface on the user system. If it is desired that the ideal profile is not changed (NO), a response indicating such is transmitted to the local compliance engine in step 908. If it is desired that the ideal profile be updated to alleviate the mismatches (YES), the ideal profile is updated in step 904. Updating the ideal profile may include one or more compliance requirements in the ideal profile. In step 906, an option is provided, e.g., via a graphical user interface on the user system, for applying the updates to the ideal profile to other ideal profiles in the region. If the update to the ideal profile is not to be applied to other ideal profiles (NO), a response indicating the update to the ideal profile is transmitted to the local compliance engine in step 908. If the update to the ideal profile is to be applied to other ideal profiles (YES), a response include indicating the update to the ideal profile (generated in step 904) as well as an indication of the other identified ideal profiles that are to be similarly updated are transmitted to the local compliance engine in step 908. In one or more embodiments, the local compliance engine may then apply the update to one or more ideal profiles and then also notify the centralized compliance system of the updates to the verification process.

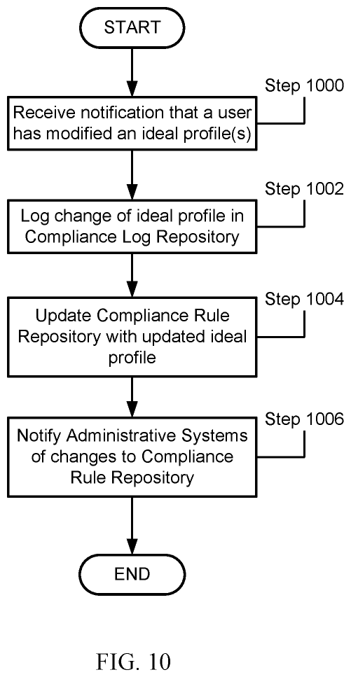

FIG. 10 shows a flowchart for reporting compliance verifications in accordance with one or more embodiments of the invention. The method shown in FIG. 10 may be performed by, for example, the central compliance system. Other components of the system illustrated in FIG. 1 may perform the method of FIG. 10 without departing from the invention. In step 1000, a notification is received that indicates a user has modified an ideal profile (e.g., the notification that was issued by the local compliance engine upon receipt of the update result from step 908). In step 1002, the change to the ideal profile is logged in the compliance log repository. The compliance rule repository is updated with the ideal profile containing the updated compliance rule in step 1004. The administrative systems may be notified of the changes to the compliance rule repository in step 1006.

As discussed above, embodiments of the invention may be implemented using computing devices. FIG. 11 shows a diagram of a computing device in accordance with one or more embodiments of the invention. The computing device (1100) may include one or more computer processors (1102), non-persistent storage (1104) (e.g., volatile memory, such as random access memory (RAM), cache memory), persistent storage (1106) (e.g., a hard disk, an optical drive such as a compact disk (CD) drive or digital versatile disk (DVD) drive, a flash memory, etc.), a communication interface (1112) (e.g., Bluetooth interface, infrared interface, network interface, optical interface, etc.), input devices (1110), output devices (1108), and numerous other elements (not shown) and functionalities. Each of these components is described below.

In one embodiment of the invention, the computer processor(s) (1102) may be an integrated circuit for processing instructions. For example, the computer processor(s) may be one or more cores or micro-cores of a processor. The computing device (1100) may also include one or more input devices (1110), such as a touchscreen, keyboard, mouse, microphone, touchpad, electronic pen, or any other type of input device. Further, the communication interface (1112) may include an integrated circuit for connecting the computing device (1100) to a network (not shown) (e.g., a local area network (LAN), a wide area network (WAN) such as the Internet, mobile network, or any other type of network) and/or to another device, such as another computing device.

In one embodiment of the invention, the computing device (1100) may include one or more output devices (1108), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (1102), non-persistent storage (1104), and persistent storage (1106). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

Embodiments disclosed herein may advantageously provide a central location for legal compliance in backup systems. Embodiments ensure audit compliance alerts and auto-enforcement of profiling to assure such compliance. Embodiments provide an distributed compliance engine architecture to achieve multi-site auto-enforcement of the audit and legal compliances for data protection across multiple regions. In some embodiments disclosed herein, the backup administrators may be relieved from the concern for maintaining compliance for distinct locations. Further, in some embodiments, the user may alerted to correct characteristics of the ideal profile, or similar profiles. Such features may help insulate the backup systems from liability of any non-compliance.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A method for verifying compliance of data objects in backup systems, the method comprising:
obtaining, by a local compliance engine, a data profile of a data object, wherein the data object is stored on a production host in a region;
identifying, by the local compliance engine, an ideal profile corresponding to the data profile;
comparing the data profile to the ideal profile;
identifying mismatches between the data profile and the ideal profile based on the comparison;
generating an alert based on the identified mismatches; and
transmitting an alert to a user system and a centralized compliance system.

2. The method of claim 1, wherein comparing the data profile to the ideal profile further comprises:
selecting a compliance requirement from the ideal profile;
obtain a corresponding compliance characteristic from the data profile; and
comparing the compliance requirement from the ideal profile to the corresponding compliance characteristic from the data profile.

3. The method of claim 1, further comprising:
receiving, in response to transmitting the alert, an update to the ideal profile from the user system, wherein the update specifies a modification to the compliance requirement;
modifying the ideal profile based on update to obtain an updated ideal profile; and
transmitting the updated ideal profile to a centralized compliance system.

4. The method of claim 3, wherein the update comprises an indication to apply the modification to the compliance requirement to a second ideal profile.

5. The method of claim 4, further comprising:
updating, by the local compliance engine, the second ideal profile to obtain a second updated ideal profile; and
sending a notification to a centralized compliance system, wherein the notification specifies that ideal profile was modified to obtain the updated ideal profile and that the second ideal profile was modified to obtain the updated second ideal profile.

6. The method of claim 1, wherein the compliance requirement comprises a region specific legal requirement associated with a region in which the production host is located.

7. The method of claim 1, further comprising:
obtaining the ideal profile from a centralized compliance system,
wherein the ideal profile is generated by the centralized compliance system based on a compliance rule stored in a compliance rule repository.

8. A non-transitory computer readable medium comprising computer readable program code, which when executed by a computer processor enables the computer processor to perform a method for verifying compliance of data objects in backup systems, the method comprising:
obtaining, by a local compliance engine, a data profile of a data object, wherein the data object is stored on a production host in a region;
identifying, by the local compliance engine, an ideal profile corresponding to the data profile;
comparing the data profile to the ideal profile;
identifying mismatches between the data profile and the ideal profile based on the comparison;
generating an alert based on the identified mismatches; and
transmitting an alert to a user system and a centralized compliance system.

9. The non-transitory computer readable medium of claim 8, wherein comparing the data profile to the ideal profile further comprises:
selecting a compliance requirement from the ideal profile;
obtain a corresponding compliance characteristic from the data profile; and
comparing the compliance requirement from the ideal profile to the corresponding compliance characteristic from the data profile.

10. The non-transitory computer readable medium of claim 8, further comprising:
receiving, in response to transmitting the alert, an update to the ideal profile from the user system, wherein the update specifies a modification to the compliance requirement;
modifying the ideal profile based on update to obtain an updated ideal profile; and
transmitting the updated ideal profile to a centralized compliance system.

11. The non-transitory computer readable medium of claim 10, further comprising:
updating, by the local compliance engine, the second ideal profile to obtain a second updated ideal profile; and
sending a notification to a centralized compliance system, wherein the notification specifies that ideal profile was modified to obtain the updated ideal profile and that the second ideal profile was modified to obtain the updated second ideal profile.

12. The non-transitory computer readable medium of claim 8, wherein the compliance requirement comprises a region specific legal requirement associated with a region in which the production host is located.

13. The non-transitory computer readable medium of claim 8, further comprising:
obtaining the ideal profile from a centralized compliance system,
wherein the ideal profile is generated by the centralized compliance system based on a compliance rule stored in a compliance rule repository.

14. A system, comprising:
a processor; and
memory comprising instructions, which when executed by the processor, perform a method, the method comprising:
obtaining, by a local compliance engine, a data profile of a data object, wherein the data object is stored on a production host in a region;
identifying, by the local compliance engine, an ideal profile corresponding to the data profile;
comparing the data profile to the ideal profile;
identifying mismatches between the data profile and the ideal profile based on the comparison;
generating an alert based on the identified mismatches; and
transmitting an alert to a user system and a centralized compliance system.

15. The system of claim 14, wherein comparing the data profile to the ideal profile further comprises:
selecting a compliance requirement from the ideal profile;
obtain a corresponding compliance characteristic from the data profile; and
comparing the compliance requirement from the ideal profile to the corresponding compliance characteristic from the data profile.

16. The system of claim 14, wherein the method further comprises:
receiving, in response to transmitting the alert, an update to the ideal profile from the user system, wherein the update specifies a modification to the compliance requirement;
modifying the ideal profile based on update to obtain an updated ideal profile; and
transmitting the updated ideal profile to a centralized compliance system.

17. The system of claim 16, wherein the update comprises an indication to apply the modification to the compliance requirement to a second ideal profile.

18. The system of claim 17, wherein the method further comprises:
updating, by the local compliance engine, the second ideal profile to obtain a second updated ideal profile; and
sending a notification to a centralized compliance system, wherein the notification specifies that ideal profile was modified to obtain the updated ideal profile and that the second ideal profile was modified to obtain the updated second ideal profile.

19. The system of claim 14, wherein the compliance requirement comprises a region specific legal requirement associated with a region in which the production host is located.

20. The system of claim 14, wherein the method further comprises:
obtaining the ideal profile from a centralized compliance system,
wherein the ideal profile is generated by the centralized compliance system based on a compliance rule stored in a compliance rule repository.
